(19) United States
(12) Patent Application Publication
(10) Pub. No.: US 2003/0189608 A1
(43) Pub. Date: Oct. 9, 2003

(54) INK JET PRINTER WITH AN INDEPENDENT DRIVING CIRCUIT FOR PREHEAT AND HEAT MAINTENANCE

(76) Inventors: Hao-Feng Hung, Taipei City (TW); Chien-Hsien Ho, I-Lan City (TW); Ying-Chen Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,283

(22) Filed: Mar. 27, 2003

(30) Foreign Application Priority Data
Apr. 3, 2002 (TW) 091106790

(51) Int. Cl. B41J 29/38

(52) U.S. Cl. 347/9; 347/14

(57) ABSTRACT

An ink jet printer with an independent preheating driving circuit includes at least an ink jet unit. Each ink jet unit has an input end for receiving energy, and a corresponding nozzle. When energy received by the ink jet unit via the input end exceeds a predetermined threshold value, the ink jet unit ejects ink from the nozzle. The printer also has a first driving circuit electrically connected to the input end for providing energy for printing, and a second driving circuit electrically connected to the input end for providing preheating energy. When the ink jet unit receives energy from the first driving circuit for printing, the second driving circuit stops providing the preheating energy to the ink jet unit.

### BACKGROUND OF INVENTION

1. Field of the Invention

The present invention relates to an ink jet printer, and more particularly, to an ink jet printer with an independent driving circuit for preheat and heat maintenance.

2. Description of the Prior Art

Ink jet printers have many advantages, such as low-cost and high printing quality, and have become one of the most popular printing devices.

Please refer to FIG. 1, which is a schematic diagram of a circuit of a prior art ink jet printer 10. The printer 10 comprises a plurality of ink jet units A11 to A13, A21 to A23, and A31 to A33 disposed in a matrix arrangement. The printer 10 also comprises a power circuit 14 for providing energy, a controller 12 for controlling the printer 10, an address circuit 16A for controlling the plurality of ink jet units A11 to A33, and a driving circuit 16B for driving the plurality of ink jet units A11 to A33. The controller 12 is electrically connected to the address circuit 16A and to the driving circuit 16B. As each ink jet unit has the same structure, the ink jet unit A13 is described as an example. The ink jet unit A13 has a nozzle K, a heating unit D, and a field effect transistor (FET) T. The gate of the FET T is a control end of the ink jet unit A13. The source and the drain of the FET T are respectively connected to ground and to one end of the heating unit D. The other end of the heating unit D serves as an input end of the ink jet unit A13, and is connected to a node Ti. The heating unit D is usually installed in an ink tank (not shown). When receiving electrical energy, the heating unit D transforms the electrical energy into thermal energy, which heats ink in the ink tank. When the temperature of the ink exceeds a specific temperature, the ink jet unit A13 ejects the ink via the nozzle K.

For controlling the plurality of ink jet units A11 to A33, the address circuit 16A comprises three corresponding address lines Aa1 to Aa3 disposed in rows. That is, the address line Aa1 is connected to the control ends of the ink jet units A11, A12, and A13, the address line Aa2 is connected to the control ends of the ink jet units A21, A22, and A23, and the address line Aa3 is connected to the control ends of the ink jet units A31, A32, and A33. For driving the plurality of ink jet units, the driving circuit 16B comprises three driving lines Pa1 to Pa3 disposed in columns. That is, the driving line Pa1 is connected to the input ends of the ink jet units A11, A21, and A31, the driving line Pa2 is connected to the input ends of the ink jet units A12, A22, and A32, and the driving line Pa3 is connected to the input ends of the inkjet units A13, A23, and A33. The address circuit 16A is capable of generating an enable signal and selectively transmitting the enable signal to different address lines according to the controller 12 using the energy provided by the power circuit 14. In a same manner, the driving circuit 16B is capable of generating an enable signal and selectively transmitting the enable signal to one or more driving lines according to the controller 12 using the energy provider by the power circuit 14.

The operation of the printer 10 will now be described. The address circuit 16A generates an enable signal on the address line Aa1 to activate the FET T of the ink jet unit A13 (as an example). At the same time, the driving circuit 16B generates an enable signal on the driving line Pa3. The heating unit D of the ink jet unit A13 transforms the electrical energy provided by the power circuit 14 into thermal energy to heat the ink in the ink tank. The ink jet unit A13 then ejects the heated ink via the corresponding nozzle K. If the controller 12 controls the address circuit 16A to stop generating the enable signal on the address line Aa1 or controls the driving circuit 16B to stop generating the enable signal on the driving line Pa3, the ink jet unit A13 will stop ejecting ink.

An uneven heat distribution among the plurality of ink jet units A11 to A33 becomes apparent when the printer 10 is operating. After-receiving energy generated by the power circuit 14, each ink jet unit retains some residual heat. If continually provided with the same energy, each ink jet unit will eject ink at a different volume, which is evident by dots printed by the printer 10 having different sizes. Additionally, because a quantity of ejected ink for each ink jet units is different, this heat-accumulation effect is present with varying degree among the plurality of ink jet units A11 to A33.

To solve the above problem, the prior art printer 10 must first execute a preheat process. In the preheat process the power circuit 14 provides energy to heat each heating unit D to a predetermined temperature when the printer 10 is about to print. Consequently, the temperature of each heating unit D after the printer 10 has executed the preheat process is almost identical to that after the printer 10 has printed for some time. Furthermore, different ink jet units can be preheated independently, for example, by preheating an ink jet unit which seldom ejects ink so that the temperature of that ink jet unit is almost identical to that of the ink jet unit which ejects ink often. As a result, the sizes of dots printed by the different ink jet units are almost the same.

According to the prior art printer 10, the preheat process is executed by the driving circuit 16B. That is, the power circuit 14 generates energy and the driving circuit 16B provides the energy to each ink jet unit as preheat energy. Typically, the preheat energy is different from that needed for executing a normal printing process, with the former usually being smaller than the latter. In other words, the driving circuit 16B needs to provide at least two energy levels, and this is accomplished by providing different voltage levels, different current levels, or different durations of the enable signal. Thus, the driving circuit 16B of the printer 10 is overly complicated and the cost of the prior art printer 10 is unnecessarily high.

### SUMMARY OF INVENTION

It is therefore a primary objective of the claimed invention to provide a printer having an independent preheat driving circuit with simplified structure to solve the problems of the prior art.

The claimed invention provides an ink jet printer. The printer comprises at least an ink jet unit comprising an input end for receiving energy, and a corresponding nozzle. When energy received by the ink jet unit via the input end exceeds a predetermined threshold value, the ink jet unit ejects ink from the nozzle. The printer also has a first driving circuit electrically connected to the input end for providing energy, and a second driving circuit electrically connected to the input end for providing energy. When the ink jet unit receives energy provided by the first driving circuit, the second driving circuit stops providing energy to the ink jet unit.

It is an advantage of the claimed invention that the printer has an independent preheat driving circuit. The independent preheat circuit simplifies the driving circuit and reduces the cost of manufacturing the printer.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a prior art ink jet printer circuit.

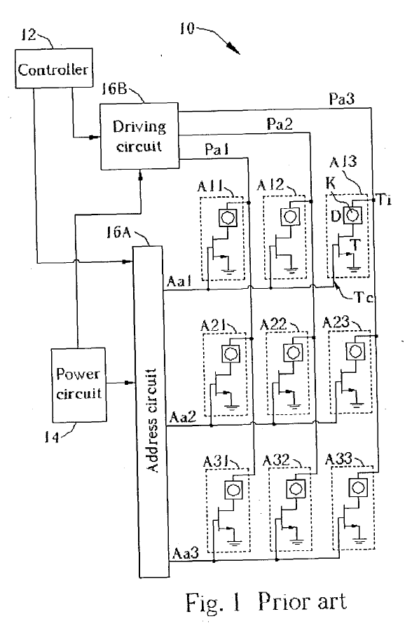

FIG. 2 is a schematic diagram of a first embodiment of an ink jet printer according to the present invention.

FIG. 3 is a schematic diagram of a second embodiment of an ink jet printer according to the present invention.

### DETAILED DESCRIPTION

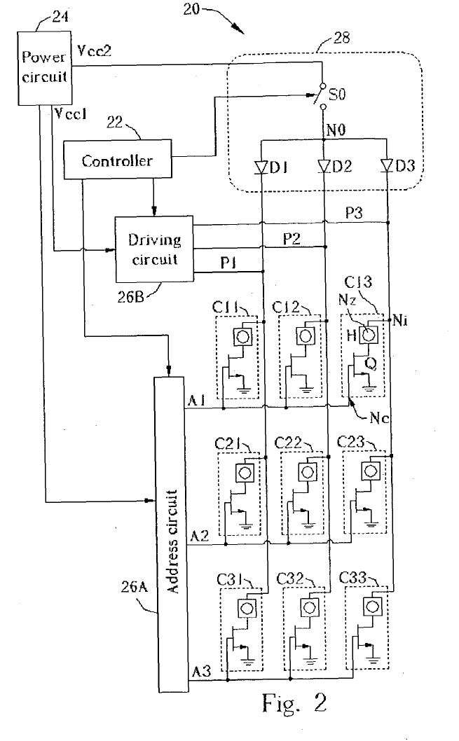

Please refer to FIG. 2, which is a schematic diagram of a circuit of an ink jet printer 20 according to the present invention. The printer 20 comprises a plurality of ink jet units C11 to C13, C21 to C23, and C31 to C33. The printer 20 also comprises a power circuit 24 for providing energy, a controller 22 for controlling the printer 20, an address circuit 26A for controlling the plurality of ink jet units C11 to C33, a driving circuit 26B for driving the plurality of ink jet units C11 to C33, and a second driving circuit 28 for preheating the plurality of ink jet units C11 to C33. Similar to the prior art printer, each ink jet unit has the same structure. Consider the ink jet unit C13 as an example. The ink jet unit C13 has a nozzle Nz, a heating unit H, and a field effect transistor (FET) Q. The gate of the FET Q serves as a control end Nc of the ink jet unit C13. The source and the drain of the FET T are respectively connected to ground and to one end of the heating unit H. The other end of the heating unit H serves as an input end of the ink jet unit C13, which is connected to a node Ni. For controlling the plurality of ink jet units, the address circuit 26A comprises three corresponding address lines A1 to A3 disposed in rows. That is, the address line A1 is connected to the control ends of the ink jet units C11, C12, and C13, the address line A2 is connected to the control ends of the ink jet units C21, C22, and C23, and the address line A3 is connected to the control ends of the ink jet units C31, C32, and C33. For driving the plurality of ink jet units, the driving circuit comprises three driving lines P1 to P3. That is, the driving line P1 is connected to the input ends of the ink jet units C11, C21, and C31, the driving line P2 is connected to the input ends of the inkjet units C12, C22, and C32, and the driving line P3 is connected to the input ends of the ink jet units C13, C23, and C33.

The printer 20 further comprises a second driving circuit 28 for controlling preheating operations of the plurality of ink jet units C11 to C33. The second driving circuit 28 comprises a switch S0 and three diodes D1 to D3. The cathodes of the diodes D1 to D3 are respectively connected to the driving lines P1 to P3. The anodes of the diodes D1 to D3 are all connected to the switch S0 by way of a node N0. The controller 22 controls the connection of the switch S0. When the switch is closed, energy provided by the power circuit 24 is transmitted to the node N0. When the switch S0 is open, the power circuit 24 is disconnected from the switch S0. The diodes D1, D2, and D3 are provided to prevent a short circuit from occurring at node N0.

The operation of the printer 20 will now be described. The controller 22 closes the switch S0 and controls the driving circuit 26B to not provide energy before the printer 20 has preheated the plurality of ink jet units C11 to C33. That is, the driving circuit 26B will not provide any energy to the plurality of ink jet units C11 to C33. Instead, the second driving circuit 28 provides preheat energy to the plurality of ink jet units C11 to C33 via the closed switch S0. In particular, to preheat the ink jet units C21, C22, and C23, the address circuit 26A sends an enable signal to the address line A2 to activate the corresponding FETs Q installed in the ink jet units C21, C22, and C23. As a result, the corresponding ink jet units receive energy provided by the power circuit 24 via the closed switch S0. Of course, the address circuit 26A can also send the enable signal to all of the address lines A1, A2, and A3 to activate all of the FETs in the plurality of ink jet units C11 to C33. In this way, all of the ink jet units C11 to C33 can receive preheat energy.

When the printer 20 is about to print, the controller 22 opens the switch S0 causing the second driving circuit 28 to cease providing preheat energy to the plurality of ink jet units C11 to C33. At this time, the control circuit 22 also activates the driving circuit 26B. For example, if the ink jet unit C22 is to eject ink, the address circuit 26A sends an enable signal to the address line A2 to activate the corresponding FET Q installed in the ink jet unit C22. The driving circuit 26B will also send an enable signal to the driving line P2 so that the energy provided by power circuit 24 is transmitted to the ink jet unit C22. Likewise, if the controller 22 controls the address circuit 26A to stop generating the enable signal on the address line A2 or controls the driving circuit 26B to stop generating the enable signal on the driving line P2, the ink jet unit C22 will stop ejecting ink.

As described previously, the energy required for preheating and the energy required for printing are different. The energy provided for printing must exceed a predetermined threshold value for an ink jet unit to eject ink, so the energy for preheating should be smaller than the predetermined threshold value. According to the present invention, the power circuit 24 uses two different voltages Vcc1 and Vcc2, the voltage level Vcc1 being higher than the voltage level Vcc2, to provide energy to the driving circuit 26B and to the second driving circuit 28 respectively. Additionally, changing the closed-state duration of the switch S0 can also control the preheat energy received by the plurality of ink jet units C11 to C33. That is, a short duration results in a low preheat energy, and a longer duration results in a higher preheat energy.

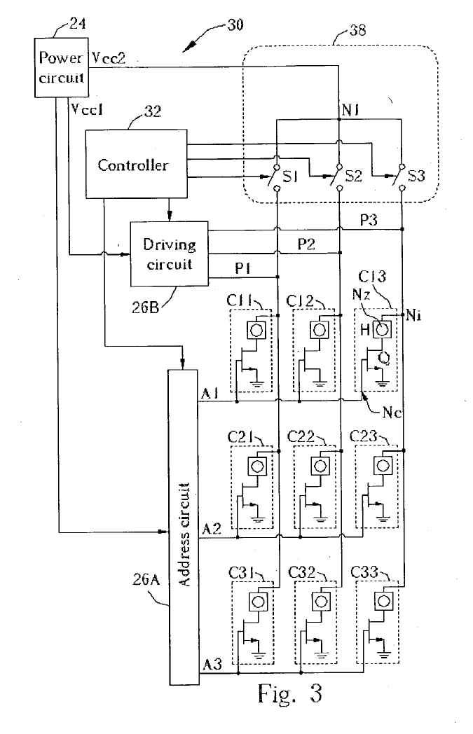

Please refer to FIG. 3, which is a schematic diagram of a second embodiment according to the present invention. For convenience, components in FIG. 3 with the same reference numbers as in FIG. 2 have the same functions and operations. These components include the power circuit 24, the address circuit 26A, the driving circuit 26B, the plurality of ink jet units C11 to C33, the address lines A1 to A3, and the driving lines P1 to P3. A printer 30 comprises a controller 32 for controlling the printer 30 and a second driving circuit 38 for providing preheat energy. The second driving circuit 38 comprises three switches S1, S2, and S3 respectively connected to the three driving lines P1, P2, and P3. Each switch is controlled by the controller 32. When the controller 32 closes a switch, the corresponding driving line is connected to the power circuit 24 via the node N1. Identical to the operation of the first embodiment, the power circuit 24 provides energy corresponding to the voltage Vcc1 to the driving circuit 26B and provides energy corresponding to the voltage Vcc2 to the second driving circuit 38.

Similar to the operation of the printer 20 of the first embodiment, when the printer 30 is executing a preheat process, the controller 32 controls the driving circuit 26B to stop providing energy, and controls the second driving circuit 38 to provide preheat energy to the plurality of ink jet units C11 to C33. The controller 32 is capable of controlling the preheating of any ink jet unit by enabling a corresponding driving line and by closing the corresponding switch. For example, to preheat the ink jet unit C32, the controller 32 closes the switch S2 and controls the address circuit 26A to send an enable signal to the driving address line A3 to activate the FET Q installed in the ink jet unit C32. Then the ink jet unit C32 receives the preheat energy generated by the power circuit 24 corresponding to the voltage Vcc2 via the node N1 and the closed switch S2. Similarly, the controller 32 is capable of preheating a group of specific ink jet units during a preheat process. For example, the controller 32 can preheats a group of ink jet units that seldom eject ink. Of course, the controller 32 also can preheat a group of the plurality of ink jet units C11 to C33 according to other preheat requirements.

When the printer 30 has completed the preheat process and is ready to print, the controller 32 opens the switches S1, S2, and S3, and the power circuit 24 provides energy corresponding to the voltage Vcc1 to the plurality of ink jet units C11 to C33 via the address circuit 26A and to driving circuit 26B. The operation of each ink jet unit is the same as described previously. Opened switches S1, S2, and S3 can also prevent the three driving lines P1 to P3 from shorting together.

For both embodiments previously discussed, in practical application, the controller 32 preheats ink jet units in a row immediately after the ink jet units in the row have ejected ink. For example, after the address circuit 26A has sent an enable signal to the address line A1, the controller 32 (or the controller 22) controls the ink jet units C11, C12, and C13 to eject ink. Then the driving circuit 26B stops providing energy and the second driving circuit 38 (or the second driving circuit 28) provides the preheat energy to the ink jet units. Naturally, the controller 32 in the second embodiment can preheat any ink jet unit C11, C12, or C13 by further closing the corresponding switch S1, S2, or S3. After driving and preheating all the ink jet units installed on the driving line A1, the controller 32 then executes the same driving-preheating process on the ink jet units installed on the address line A2. In this way, the controller 32 cycles thought all the rows of ink jet units providing driving and preheating energy.

Additionally, the printer 30 is also capable of sequentially preheating each ink jet unit after all the ink jet units have ejected ink. To sequentially eject ink, the address circuit 26A sends an enable signal to all of the address lines one at a time, and the driving circuit 26B drives each ink jet unit on the corresponding enabled address line to eject ink. Then to sequentially preheat ink jet units, the address circuit 26A again sends an enable signal to all of the address lines one at a time, and the second driving circuit 28 preheats each ink jet unit on the corresponding enabled address line. Of course, the controller 32 can also control the address circuit 26A and the driving circuit 26B to simultaneously preheat all of the ink jet units C11 to C33 of the printer 30.

The present invention printer 30 comprises not only a driving circuit for operating each ink jet unit, but also an independent second driving circuit for providing preheat energy. This simplifies the prior art driving circuit, which executes both the driving and the preheating operations of the printer. Since the second driving circuit is only required to provide a small preheat energy, the demand for high power tolerance of the second driving circuit is not necessary and consequently the cost for manufacturing the second driving circuit is reduced. Furthermore, by varying the voltage Vcc2 or the duration of an enable signal the second driving circuit can provide different preheat energies. In contrast to the prior art, the present invention printer uses a second driving circuit as an independent preheating driving circuit, which is controlled by a controller according to different printer operation requirements.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. An inkjet printing apparatus comprising:
at least an ink jet unit comprising an input end for receiving energy and a corresponding nozzle; wherein when energy received by the ink jet unit via the input end exceeds a predetermined threshold value, the ink jet unit ejects ink from the nozzle;
a first driving circuit electrically connected to the input end for providing energy; and
a second driving circuit electrically connected to the input end for providing energy,
wherein when the ink jet unit receives energy provided by the first driving circuit, the second driving circuit stops providing energy to the ink jet unit.

2. The apparatus of claim 1 wherein when the inkjet unit receives energy provided by the second driving circuit, the first driving circuit stops providing energy to the ink jet unit.

3. The apparatus of claim 1 wherein energy provided by the first driving circuit does not exceed the predetermined threshold value.

4. The apparatus of claim 1 wherein energy provided by the second driving circuit does not exceed the predetermined threshold value.

5. The apparatus of claim 1 further comprising an address circuit connected to the ink jet unit for providing an enable signal; the ink jet unit further comprising a control end for receiving the enable signal; the ink jet unit receiving energy via the input end when receiving the enable signal at the control end.

6. The apparatus of claim 1 wherein the ink jet unit further comprises a heating element connected to the input end for transforming energy received via the input end into heat.

7. The apparatus of claim 1 further comprising a controller for controlling the first driving circuit and the second driving circuit; wherein when the first driving circuit provides energy, the controller controls the second driving circuit to stop providing energy, and when the second driving circuit provides energy, the controller controls the first driving circuit to stop providing energy.

8. An ink jet printing apparatus comprising:
a plurality of ink jet units; each ink jet unit comprising an input end for receiving energy and a corresponding nozzle; wherein when energy received by each ink jet unit via the input end exceeds a predetermined threshold value, the ink jet unit ejects ink from the nozzle;
a first driving circuit electrically connected to each input end for providing a first energy that is greater than the predetermined threshold value; and
a second driving circuit electrically connected to the input end for providing a second energy that is less than the predetermined threshold value to compensate for a the differences of temperature among the ink jet units.

9. The apparatus of claim 8 wherein when the plurality of ink jet units receive energy provided by the first driving circuit, the second driving circuit stops providing energy to the plurality of ink jet units.

10. The apparatus of claim 8 wherein when the plurality of ink jet units receives energy provided by the second driving circuit, the first driving circuit stops providing energy to the plurality of ink jet units.

11. An ink jet printing apparatus comprising a plurality of ink jet units; each ink jet unit comprising a nozzle, and an input end for receiving a first energy and for receiving a second energy that is less than the first energy; wherein when the plurality of ink jet units receive the first energy provided by a first driving circuit, the plurality of ink jet units ejects ink via the nozzles, and when the plurality of ink jet units receive the second energy provided by a second driving circuit, the plurality of ink jet units are heated to compensate for the differences of temperature among the ink jet units.

12. The apparatus of claim 11 wherein when the first driving circuit provides the first energy to the plurality of ink jet units, the second driving circuit stops providing the second energy.

13. The apparatus of claim 11 wherein when the second driving circuit provides the second energy to the plurality of ink jet units, the first driving circuit stops providing the first energy.
